(19) United States
(12) Patent Application Publication
(10) Pub. No.: US 2018/0211308 A1
(43) Pub. Date: Jul. 26, 2018

(54) SYSTEM AND METHOD FOR IDENTIFYING AND BOOKING STYLE-CRITICAL SERVICE PROVIDERS

(71) Applicant: Milan Cheeks, Moriches, NY (US)

(72) Inventor: Milan Cheeks, Moriches, NY (US)

(21) Appl. No.: 15/869,020

(22) Filed: Jan. 11, 2018

Related U.S. Application Data
(60) Provisional application No. 62/450,897, filed on Jan. 26, 2017.

(51) Int. Cl. G06Q 30/06; G06Q 50/10

(52) U.S. Cl. CPC G06Q 30/0643; G06Q 50/10; G06Q 30/0613; G06Q 30/0623

(57) ABSTRACT

The present invention generally relates to a system and method that provides consumers of style-critical services with an intuitive user interface to quickly and efficiently identify style-critical service providers of interest based on a consumer's style preferences automatically determined and automatically displayed by the system in visual form with images that show the particular style or styles determined by the computer system to be most relevant to a particular consumer. The user interface may be configured as an app or web-based computer system. Style-critical services include services from hair stylists, hair salons, barbers, nail salons, tattoo artists, beauty parlors, makeup artists, body paint artists, fashion and accessory consultants, and wedding planner.

### CROSS-REFERENCE TO RELATED APPLICATIONS

This application claims the benefit of U.S. Provisional Patent Application No. 62/450,897, filed Jan. 26, 2017, titled “SYSTEM TO IDENTIFY AND BOOK STYLE-CRITICAL SERVICE PROVIDERS,” the entire disclosure of which is incorporated herein by reference.

### FIELD OF THE INVENTION

The present invention generally relates to an automated system and method to efficiently select, book and review providers of style-critical services such as hair style, make-up, nails, tattoos, and other body art via a user interface that automatically determines and displays particular subscribing providers of such services based on user preferences automatically determined by the system.

### BACKGROUND OF THE INVENTION

Known web-based sales or search systems and user interfaces generally lack specificity to a consumer's interests in a particular style, or if they allow specificity, manual input is required. Known systems lack automation and cannot be efficiently custom-tailored.

### SUMMARY OF THE INVENTION

Embodiments of the present invention are directed to a system and method that provides consumers of style-critical services with an intuitive user interface to quickly and efficiently identify style-critical service providers of interest based on a consumer's style preferences automatically determined and automatically displayed by the system in visual form, e.g. images or video links that show the particular style or styles determined by the computer system to be most relevant to a particular consumer. The user interface may be configured as an app or web-based computer system. Style-critical services include, for example, services from hair stylists, hair salons, barbers, nail salons, makeup artists, tattoo artists, body artists and other personal fashion- and style-based service providers that are subscribers to the “Style” system. The system allows subscribers to save service provider profiles to showcase their work and includes sales functions. For example, the system and method may allow direct booking, payments through the system, and reviews of subscribing service providers by users.

In accordance with a preferred embodiment of the present invention a system for identifying and booking style-critical service providers comprises: a search module; a selection module; a display module; a data store comprising at least one of user data, service provider data, and search data; and a visual output device; wherein the display module is configured to display a user interface via the visual output device. In one embodiment the user interface is configured to display a profile which is customized according to a user's choice of one or more of hair style, nail style, makeup style, tattoo style, and fashion style. In another embodiment of the present invention the service provider data comprises one or more of a name, a business address, a service location, an availability schedule, a set of services provided, and a set of particular styles specialized in for each service provider having a profile on the system.

According to another embodiment, the user interface comprises a service provider profile which comprises one or more of a name, business address, service location, and images. In accordance with some embodiments of the present invention, the images are pictures of styles specialized in by a service provider. In other preferred embodiments, the system may further comprise a plurality of tabs, buttons, icons, and dropdown menus. In some embodiments at least one of the plurality of buttons is configured to make a booking, at least one of the plurality of buttons is configured to make a phone call to a service provider, and at least one of the plurality of buttons is configured to process a payment through the system.

In accordance with an embodiment of the present invention the interface displays a review module configured to enable to user to supply the system with a review of a service provider's work which comprises one or more of a rating, a textual description, and one or more pictures of the service provider's work that is being reviewed. Other embodiments of the present invention have an interface that displays featured products selected for display by the system's determination of a user's preferences based on one or more of: a user profile in the system, a user profile in a user's social network sites, a user's browsing history, a user's appointment history, a user's reviews, a user's images placed in a review, and ratings a user's images receive. The display module may comprise a mobile device in some embodiments of the present invention and the system may optionally be configured to respond to Bluetooth Low Energy Beacon interaction by presenting at least one of notifications and advertisements when the mobile device is within range of a Bluetooth Low Energy Beacon. In the various embodiments, the mobile device preferably comprises imaging means operable to scan a Quick Response code and thereby check a user in to a service provider's location.

According to preferred embodiments of the present invention a method for identifying and booking style-critical service providers comprises the steps of: determining a user's style preferences; identifying matching service providers; selecting relevant service providers; and displaying relevant service providers. In some embodiments the step of determining a user's style preferences depends on user data comprising one or more of: the user's browsing history, the user's purchasing history, the user's profile, the user's profile images, the user's shared images, the user's tagged images, the user's liked images, the user's saved images, the user's location on profile, and the user's current location. According to yet other embodiments of the present invention the step of determining a user's style preferences depends on user data comprising one or more of: the user's browsing history, the user's purchasing history, the user's profile, the user's profile images, the user's shared images, the user's tagged images, the user's liked images, the user's saved images, the user's location on profile, and the user's current location In some embodiments the step of identifying matching service providers is based on service provider data comprising one or more of: a service provider's, the service provider's profile, the service provider's profile images, the service provider's shared images, the service provider's tagged images, the service provider's liked images, the service provider's saved images, the service provider's style selections on profile, the service provider's services provided to users, the service provider's reviews by other users, the service provider's ratings by other users, the service provider's favorites by other users, the service provider's lists by other users, the service provider's past bookings by other users, the service provider's information from social networks, the service provider's availability, and the service provider's proximity. In certain embodiments of the present invention the step of displaying relevant service providers comprises displaying summaries of a subset of selected service provider profiles and providing a booking function linked to a service provider's profile. Preferably, the step of displaying relevant service providers further comprises displaying via a visual output at least one of a plurality of summary profiles of style providers, an image gallery, a user's favorite list, and a video.

According to an embodiments a system for identifying and booking style-critical service providers comprises a non-transitory, computer readable recording medium containing a computer program, which when executed by a processor, causes the system to perform the steps of: determining a user's style preferences based on service provider data comprising one or more of: a service provider's, the service provider's profile, the service provider's profile images, the service provider's shared images, the service provider's tagged images, the service provider's liked images, the service provider's saved images, the service provider's style selections on profile, the service provider's services provided to users, the service provider's reviews by other users, the service provider's ratings by other users, the service provider's favorites by other users, the service provider's lists by other users, the service provider's past bookings by other users, the service provider's information from social networks, the service provider's availability, and the service provider's proximity; identifying matching service providers; selecting relevant service providers; and displaying relevant service providers via a component of a display module of the system. In some embodiments of the present invention the step of identifying matching service providers is based on service provider data comprising one or more of: a service provider's, the service provider's profile, the service provider's profile images, the service provider's shared images, the service provider's tagged images, the service provider's liked images, the service provider's saved images, the service provider's style selections on profile, the service provider's services provided to users, the service provider's reviews by other users, the service provider's ratings by other users, the service provider's favorites by other users, the service provider's lists by other users, the service provider's past bookings by other users, the service provider's information from social networks, the service provider's availability, and the service provider's proximity and the step of displaying relevant service providers may comprise displaying summaries of a subset of selected service provider profiles and providing a booking function linked to a service provider's profile and may further comprise displaying via a visual output at least one of a plurality of summary profiles of style providers, an image gallery, a user's favorite list, and a video.

The foregoing summary of the present invention with its preferred embodiments should not be construed to limit the scope of the invention. It will be apparent to one skilled in the art that based on the embodiments as described, features of the invention may be further combined or modified without departing from its scope.

### BRIEF DESCRIPTION OF THE DRAWINGS

Accompanying this written specification is a collection of drawings of exemplary embodiments of the present invention. One of ordinary skill in the art would appreciate that these are merely exemplary embodiments, and additional and alternative embodiments may exist and still within the spirit of the invention as described herein.

FIG. 1 illustrates a schematic overview of a computing device, in accordance with embodiments of the present invention;

FIG. 2 illustrates a schematic overview of a network, in accordance with embodiments of the present invention;

FIG. 3 depicts a flow diagram illustrating processes in the user interface to generate and display relevant selections of style-critical service providers.

FIG. 4 is an illustrative screen shot of a service provider profile in accordance with an embodiment of the invention.

FIG. 5A is an illustrative screen shot of a sign-in interface in accordance with an embodiment of the invention.

FIG. 5B is an illustrative screen shot of a sign-in interface in accordance with an embodiment of the invention.

FIG. 6 is an illustrative screen shot of a service type selection interface in accordance with an embodiment of the invention.

FIG. 7 is an illustrative screen shot of a style image gallery in accordance with an embodiment of the invention.

FIG. 8A is an illustrative screen shot of a booking interface in accordance with an embodiment of the invention.

FIG. 8B is an illustrative screen shot of a booking interface in accordance with an embodiment of the invention.

FIG. 8C is an illustrative screen shot of a booking interface in accordance with an embodiment of the invention.

FIG. 8D is an illustrative screen shot of a booking interface in accordance with an embodiment of the invention.

FIG. 9 is an illustrative screen shot of a service provider's public profile in accordance with an embodiment of the invention.

FIG. 10A is an illustrative screen shot of a service provider profile in accordance with an embodiment of the invention.

FIG. 10B is an illustrative screen shot of a service provider profile in accordance with an embodiment of the invention.

### DETAILED DESCRIPTION OF THE INVENTION

The present invention generally relates to a web-based system with a unique user interface and related method to automatically search, select and display relevant style-critical search providers to a user entering the system portal. The unique interface identifies style-critical services, automatically presents consumers with relevant options, and allows them to make personal selections quickly and efficiently, without being required to manually search. Furthermore, the system is fully integrated with systems for booking, paying, and review, and allows custom-tailored profiles for consumers and service providers that automatically improve the relevance of search results.

Style-critical services may include services from hair stylists, hair salons, barbers, nail salons, tattoo artists, beauty parlors, makeup artists, body paint artists, body art artists, piercing artists, fashion and accessory consultants, and wedding planners.

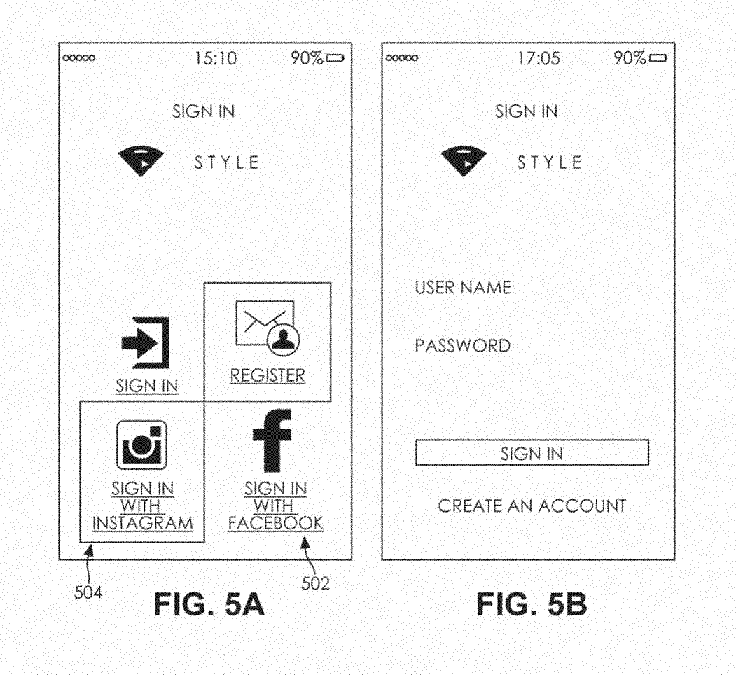

The user may be a prior user, or a new user that can sign in to the system via the interfaces depicted in FIGS. 5A-5B. For new users, before a profile is available, the service provider selection may be identified based on browsing history, and optionally of one or more of a user's social network profiles (e.g. Facebook® 502, Instagram® 204, Google®, Flicker®, photo sites), and photos therein, as can be seen in FIG. 5A. Photos may include photos identified to show the user (e.g. tagged) by the user, by a user's friends, or by a computer (e.g. Facebook®). Images uploaded by the user may be tagged by the user selecting styles automatically presented by the system (e.g. dropdown menu choices or buttons) or may be manually entered. Optionally, a user may tag images with tags corresponding to a style of interest. Optionally, using an AI image detection function, images that show style-critical features may be determined fully automatically, e.g. style of hair, makeup, or tattoos.

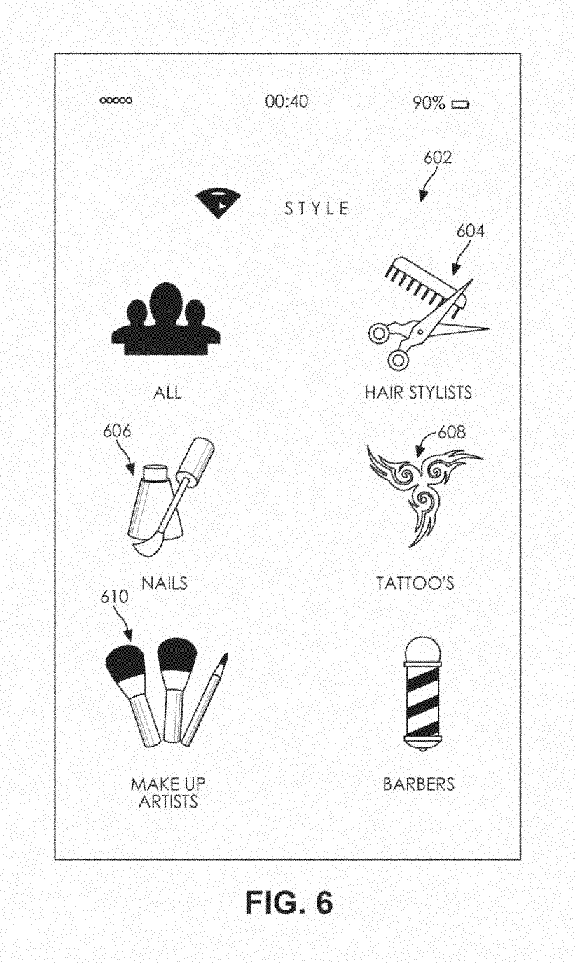

In embodiments of the invention, one of which is depicted in FIG. 6, the user interface 602 allows consumers to set up a user profile and allows service providers to set up subscriber profiles 902, and may be custom-tailored by both users and subscribers with a variety of preferences, including choice of one or more style, e.g. hair style 604, nail 606, makeup 610, tattoo 608, fashion etc., as user-preferred or as a subscriber's specialty.

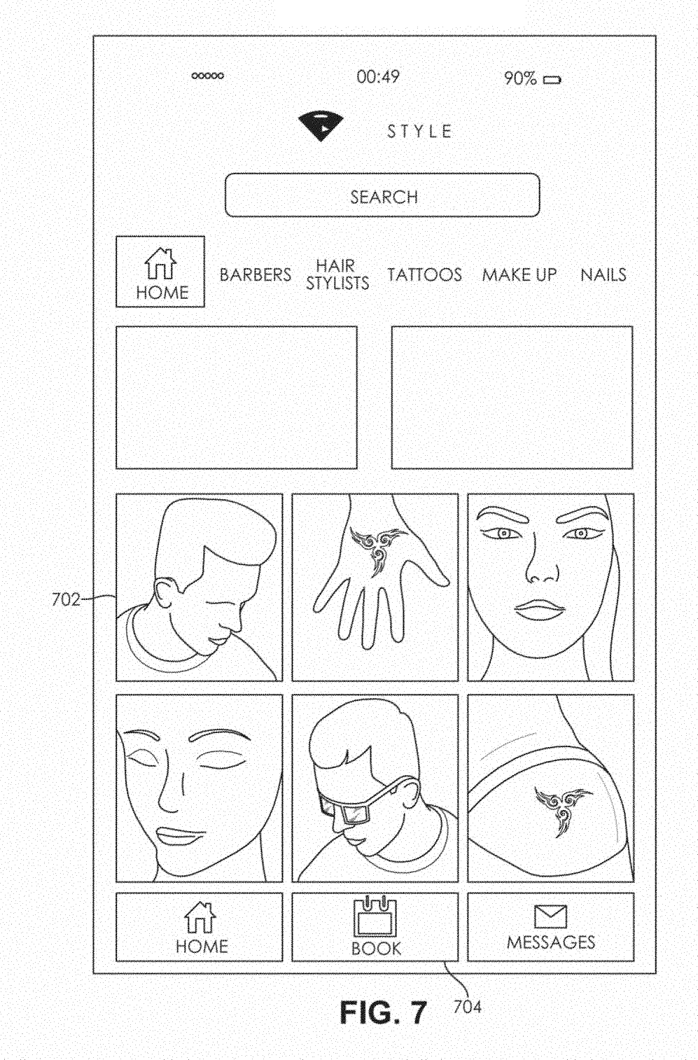

A user profile may include a user's style preferences in addition to a user name and location details. In the user profile, a user may view a newsfeed such as the one displayed in FIG. 7, a user may enter style pictures 702 into a user image gallery, save favorite service providers, see a history of past bookings 704, see reviews/ratings given and comments made. The user profile may also offer the option to create, save and share favorite lists of style-specific service providers with links to their profiles, and optionally with saved images/favorite images. Favorite lists may be private or public, and public lists may be shared or showcased by the system.

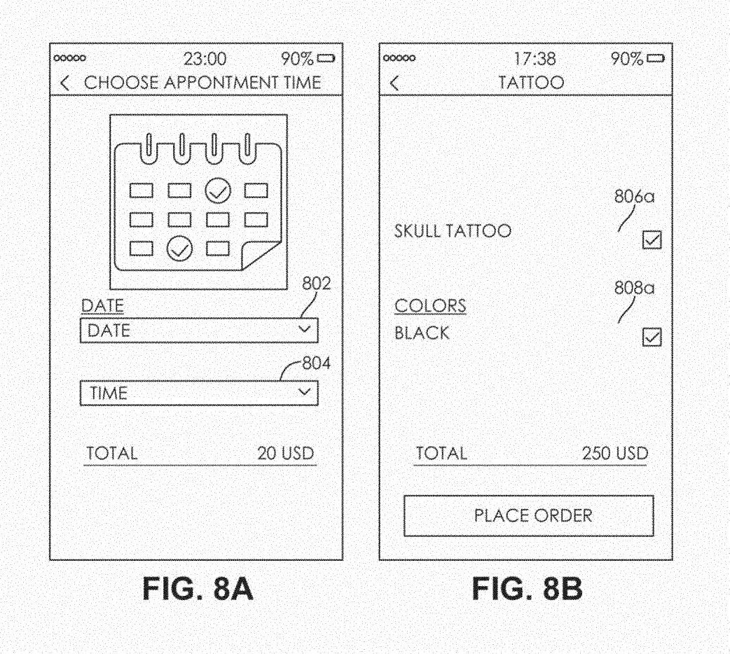

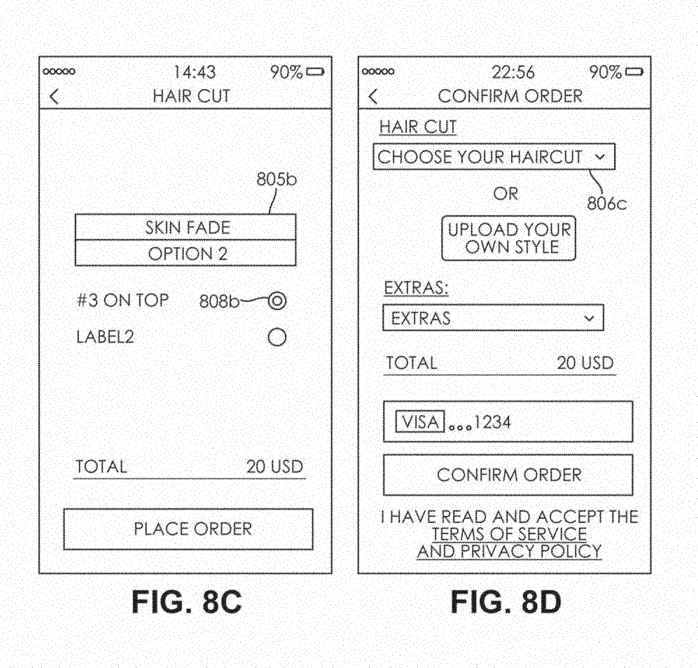

In embodiments of the invention, as depicted in FIGS. 8A-8D, the system allows consumers to directly book appointments by offering a choice of one or more location for fulfillment of the appointment. The system may include a data store with a directory of service providers such as hair and/or nail salons, tattoo parlors etc. that may include regional, national and international service providers with their details such as name, business address(es) and service location(s), availability (e.g. calendar 802 with time slots 804), services provided 806a-c and particular styles specialized in. Most relevant location choices may be automatically determined by the system based on a user's locations or preferred regions indicated in the user profile, or may be automatically determined based on appointment history, browsing history, user's location indicated by a user device such as cell phone or tablet, by the IP address of the user's computer or internet access point of the internet service, by the user's address in the profile, or by the user's address from social network sources.

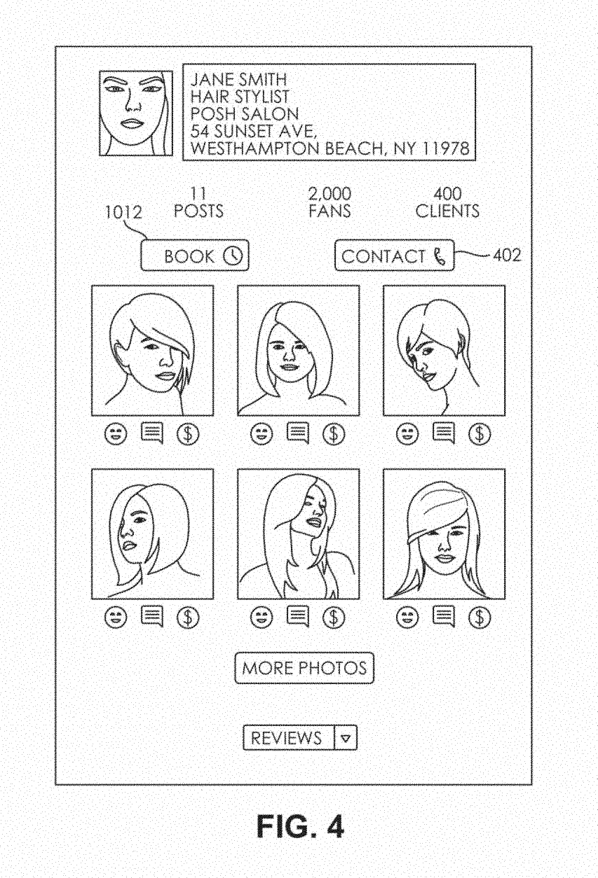

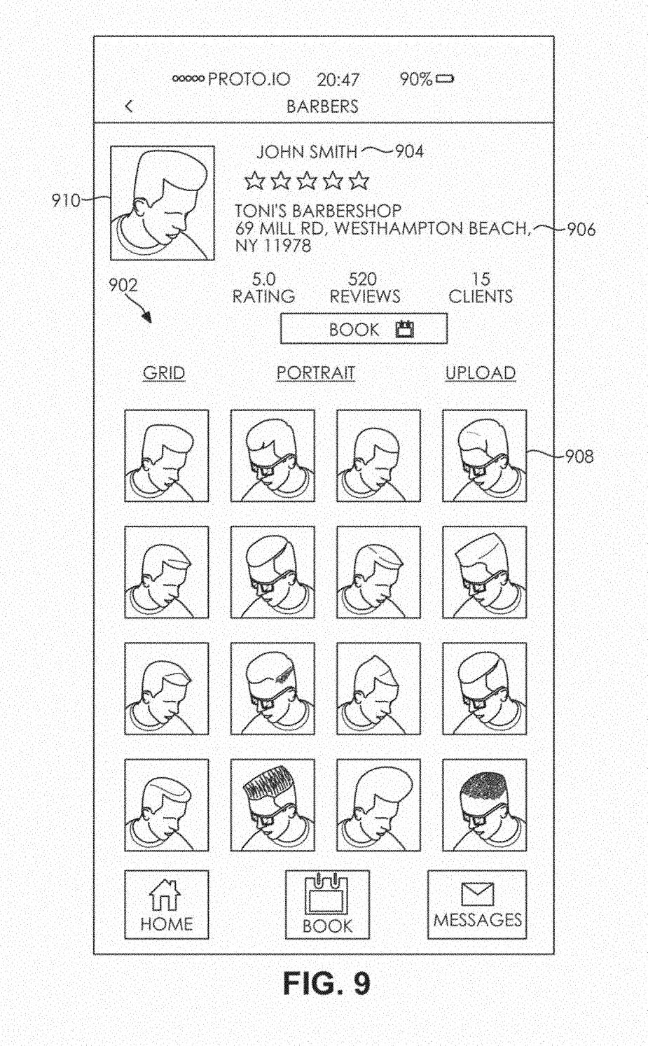

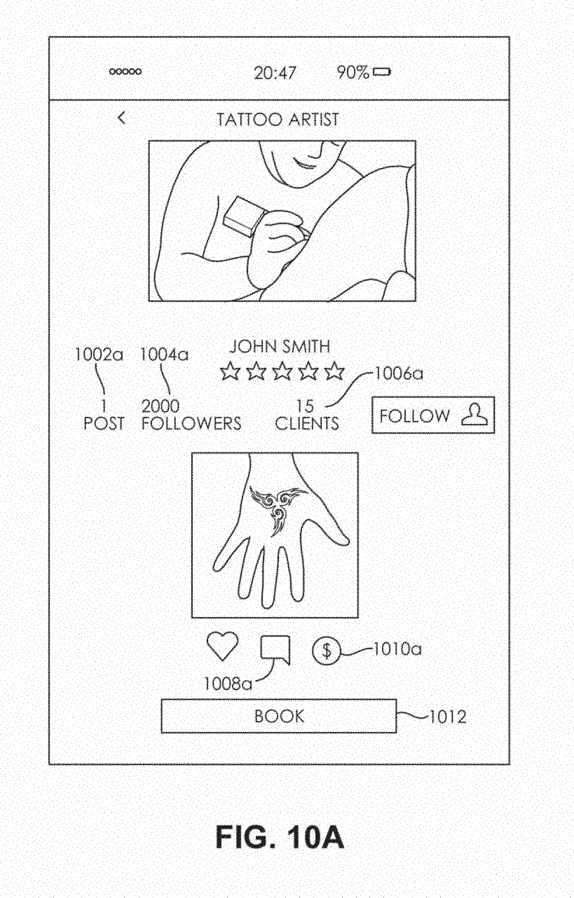

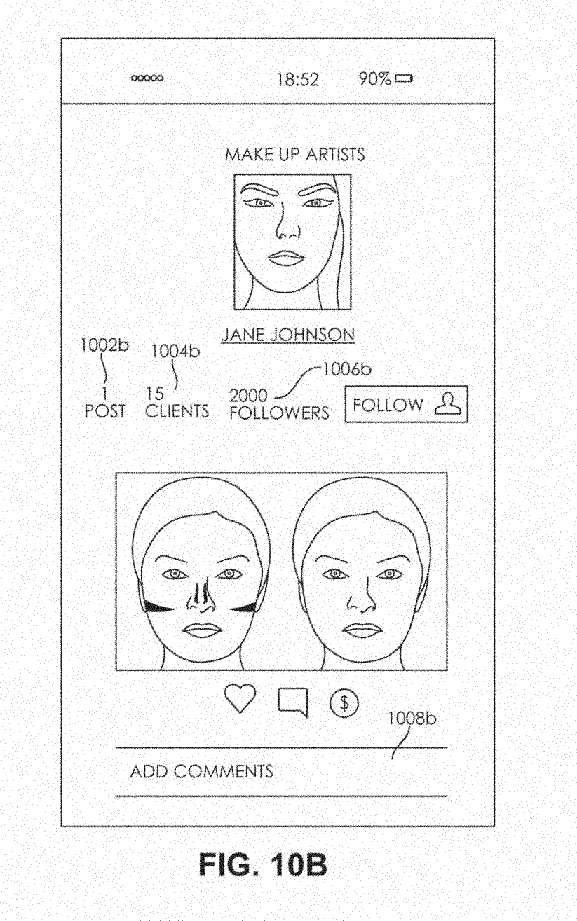

In embodiments of the invention, as shown in FIG. 9, the service provider's public profile 902 serves as an interface for the consumer and may include name 904, business address(es) 906, service location(s), and images 908 showcasing the service provider's works, including a profile image 910 and an image gallery. The images may include images of styles specialized in, e.g. a particular hair style or cut. The images may include linked information regarding consumer reviews with comments 1008a-b and prices 1010a-b. The linked information may be provided by buttons, icons, or dropdown menus. The service provider's profile includes a plurality of tabs, for example three tabs as shown in FIGS. 10A-10B: posts 1002a-b (for posts by the service provider), followers 1004a-b (e.g. selected reviews), and clients served 1006a-b (info may include number, styles, reviews, ratings general, ratings by style etc). The profile may also include a booking button 1012 configured to make a booking, a button configured to place a phone call 402 to one or more location of the service provider (with an optional dropdown menu for a plurality of locations), e.g. via internet phone service or via a user's mobile phone, and a button configured to process a direct payment through the system, e.g. via a user's credit card or credit with a store as depicted in FIGS. 4 and 10.

In certain embodiments, the system may be configured to use Near Field Communications (NFC) means to allow consumers to interact with NFC tags in order to allow for bookings or other instant action items. Various actions of the system may be engaged by interaction with NFC tags or other NFC enabled devices. One of ordinary skill in the art would appreciate that there are numerous types of events that could be processed in this manner, and embodiments of the present invention are contemplated for use with any appropriate events.

In embodiments of the invention, upon signing up, the system may present the service provider with a number of subscription options which may differ in price based on e.g. specific services offered and breadth of services, e.g. a basic subscription may include just one service (e.g. hair or tattoo), and a more comprehensive subscription may include more services. A basic subscription includes a professional profile which will showcase the past work of the professional. The profile may be automatically setup by the system through system-processed appointments of customers by the system; may automatically integrate consumer's reviews based on one or more style-specialization of the provider; and may optionally be manually edited by the service provider by adding information or by selecting from automatically provided information. The profile may include text and images of past work, an Easy Appointment Center, a royalty and promotion program, and a fan base where the service provider can entertain fans with posts about their latest work. A comprehensive subscription may cover one or more service providers, and service providers may be given the option to form a service network within the system, an optional profile for the network showcasing its members, and subprofiles for individual network members. The system may automatically offer options to change a service provider's current subscription option or suggest forming networks based on an overlapping customer base as determined automatically by the system.

In embodiments of the invention, to book an appointment in another module identified as the Easy Appointment Center part of the user/subscriber interface, the system may display a calendar with time slots for one or more chosen service providers. For the user, filter options may be provided to only show certain time periods, days, or times of the day, for a particular service provider, or a particular set of service providers. The calendar may be adjusted to a user's/subscriber's preferences e.g. starting day, time slots shown, days shown, and/or time period shown (week, month, year). The user may choose to show results for a particular service provider or a particular set of service providers. The subscriber may customize the calendar, e.g. to particular days/times worked, and day/time restrictions for particular locations. The system may automatically book time slots according to a user's and subscriber's requirements and options.

In embodiments of the invention, the system includes a review module for users to review of their service experience. A user's review may include one or more of a rating (numerical, stars, emoji), a textual description, and one or more picture of a service provider's work, e.g. of their hairstyle, outfit, or tattoo. The pictures may be included in one of the system's modules (review module, search module) to determine future results determined and displayed to users as they enter the system's web portal.

In embodiments of the invention, users may see reviews from past customers including, in particular, with respect to performance on specific styles, e.g. particular hair style or cut, type, style or technique of tattoo, fashion style etc., as well as overall performance (e.g. general rating, professionality, friendliness, competence).

In embodiments of the invention, the system includes the option for users to designate “favorite” service providers, either based on past appointments, or in a list of results of service providers automatically determined and displayed by the system.

In embodiments of the invention, the system may include featured products depending on the system's determination of a user's preferences based on one or more of: a user profile in the style system, a user profile in a user's social network sites, a user's browsing history, a user's appointment history, a user's reviews, a user's images placed in a style review, and ratings the user's style images receive. The featured products may be targeted based on a user's style preferences determined by the system and may, for example, include hair products such as shampoo, conditioner, hair mask, brushes, combs, hair dryer, makeup kit, facial mask, skin products, skin lotion, etc.

In embodiments of the invention, service providers may have the option to join a style referral program. By “sharing your style”, a service provider may make commissions on sharing and recommending options, e.g. by sharing which products they currently use and by recommending certain products to their clients, or a particular group of their clients. These products include the featured products listed above.

In embodiments of the invention, service providers may have the option to offer a promotion code that may be entered into the system by the service provider, that may then be automatically processed by the system. Automatic processing may include automatic offers sent to customers based on the system's determination of the customer's interest in a particular style offered by the service provider, a service provider's proximity in locations previously chosen by the consumer, and/or a service provider's availability in time.

In embodiments of the invention, service providers may have the option to offer royalty programs and discounts based on customer loyalty to customers, for example discounts or free appointments based on a plurality of previous appointments, e.g. free haircut or 20% discount after the 5^{th} visit.

In embodiments of the present invention the system incorporates the use of Bluetooth Low Energy (BLE) Beacon Technology to enable services and products to be marketed to users of the system. Advertisements and push notifications can be triggered to be sent to a nearby device within the range of the corresponding BLE Beacon to thereby enable service providers and others to target potential customers in a focused location-based manner. BLE Beacons are placed in various locations near which potential customers may pass and when a user with a device within the range of the BLE Beacon passes near the BLE Beacon location, the initiation of a notification, advertisement, or other event on the user's device may be triggered as chosen by a service provider or operator of the system. Further, by utilizing BLE Beacon outfitted drones or similar automatic or remotely controlled vehicles, the system enables targeted advertising in locations selected by a user via an indication of a city, ZIP code, or state. In this manner, instead of having statically located BLE Beacons, the BLE Beacon drones can be deployed to specific locations to target potential customers in locations that can be changed from time to time.

In embodiments of the present invention users may have the option of checking in to a service provider's location by scanning a Quick Response (QR) code. Scanning a QR code via the system may alert a service provider to the arrival of a customer at the service provider's location as well as stamp the next available time for the service provider's calendar.

Embodiments of the present invention will give users who are service providers the ability to “go live” and stream live video online via the system. This will permit service providers to display their abilities and work in real time and allow current or prospective customers to view the professional in action. Further, posts made by users of the system within the system's user interface will be integrated with certain other selected social media platforms. Analogously, posts made in other social media platforms will be able to be integrated into the user interface of the system as well. That is to say, for example, that a post made by a user of the system will be able to be shared, linked-to, or reposted on another social media platform, and vice versa.

In embodiments of the present invention an advertisement subscription module will provide users the option of being advertised on the system's user interface (e.g. on a mobile application interface or a browser interface) in exchange for a monthly subscription fee. In this manner, by paying a subscription fee, service providers can become more visible to users of the system or have their sponsored advertisements appear preferentially to users of the app. Preferential appearance of subscriber's advertisements may be correspond to the frequency of an advertisement's appearance, the location, duration, or other factor thereof that impacts the service provider's visibility to potential customers who are users of the system. The same module will enable service providers to advertise and to be preferentially visible on other platforms (e.g. Facebook®, Spotify®, etc.) as well. Analogously, a subscription module for clients will enable clients who are users of the system to obtain discounts on products or credits for services requested via the system in embodiments of the present invention.

In embodiments of the present invention, if service providers obtain a sufficiently high following or client base, they will have the option to obtain product placement sponsorships via the system. The system will connect high performing service providers with potential sponsors in order to generate revenue from product placement sponsorships. The service providers will have a choice of having the generated amounts credited towards their advertisement subscriptions described above or to have the amounts paid out to them directly.

In embodiments of the present invention, a conferences module of the system will provide the functionality for service provider users to be able to book and attend conferences. The conferences can be both physical and virtual. Via the system, users can book spots in conferences (e.g. hair shows, tattoo conventions, conferences sponsored by the “Style” system etc.) and will be able receive discounts for them. This will enable service providers to obtain booths to showcase their work at conferences or to book booths at a lower price (which may depend on a service provider's performance).

In embodiments of the present invention, the system comprises a module configured to present users of the system with their own virtual closet. Within this closet, users will be able to select their favorite brands/companies (e.g. Versace®, Gucci®. Fashion Nova®, etc.) or specific items as an indication of the user's interest therein or preference thereof. Provided with such a selection of brands/companies and/or items, the system is configured to trigger an event (e.g. send push notifications) on a user's device when the user passes within the range of a BLE Beacon deployed by a store carrying items or brands indicated by the selection. This module may also optionally provide the user coupons or discount codes for the selected items or brands.

Embodiments of the present invention are configured to be interoperable with peripheral card readers (e.g. credit card readers such as Square® and the like) as well as alternative non-cash payment methods such as those provided by, but not limited to, Apple Pay, Venmo, Square®, Android Pay, Samsung Pay, Zelle®, LevelUp, CurrentC, PayPal®, Bitcoin, E-Check/ACH, and Dwolla. Additionally, embodiments of the system can be configured to send service provider payouts to the service provider's bank accounts or PayPal® accounts or by generating a check to be paid to the service provider. Embodiments of the present invention may also comprise a module enabling service providers, as users of the system, to pay fees (e.g. rent owed for a chair at a hair salon). For example, if a service provider has existing or any future appointments the service provider will have the option to either give the full amount or a portion of the appointment amount to the shop owner. This will cover any fees that the service provider might have and can be done by selecting the correct payout method and percentage the service provider wishes to give.

In embodiments of the invention, in addition to the automatic selections displayed by the system, the user may have the option to use a web portal search engine provided by the system to manually search for service providers, or to search for service providers semi-automatically. In a semi-automatic search, the user is presented with one or more pre-populated user interface options. Each user interface option will gather information from one or more of: the user's profile, the user's images, the user's reviews, and/or external resources (e.g. the user's social network information and/or information from images of a user available from one or more web-sources such as Google® or Flickr®). The information is automatically analyzed by a system module and a corresponding filter option is automatically populated. For example, if past appointments have been booked on particular week days, the search may be automatically limited to those days. If past appointments have been with a particular service provider or with a group of service providers, the selection may be limited to this circle of providers, and the results may feature an overlap of available time and service providers of interest. The filter options may distinguish between different data sources, e.g. circles of providers may be automatically shown and selected distinguishing among: providers visited in the past, providers a user's friend's visited, and providers recommended by users with similar preferences or who post similar reviews/ratings. These options may be shown as drop-down menus, buttons, or preferably as a visual representation of overlapping circles of different sizes that is automatically generated by the style system, along with icons designating each type of circle shown. Preferably, the circles show icons or example pictures showing the styles available from the identified service providers. The icons may be mouse-over icons that automatically show a larger image showing a style of interest to the user.

The user may additionally limit the search based upon several criteria such as: keywords related to the service; location or service area; time and date for the service; pricing; preferred location for the service to take place (e.g. at the user's home or the office of the service provider); if a telephone consultation is desired, distance that the user is willing to travel to the service provider; and whether the service provider is willing to travel to meet the user. Once service providers are identified, the user can select a service provider and directly book an appointment online.

In embodiments of the invention, the one or more modules of the style system may perform the steps of: determining 302 a consumer's style preferences; identifying 304, through one or more automated searches in one or more data store, one or more matching service provider based on the determined user style preferences; selecting 306 a number of most relevant service providers for display (e.g. 1, 2, 3, 4, or 5); and displaying 308, by a peripheral component of the display module of the system, a visual output of the most relevant service providers within a graphic user interface. The style preferences may be determined by user data 310 which may include one or more of: a user's browsing history, purchasing history, profile, profile images, shared images, tagged images, liked images, saved images, location on profile, current location (as determined by GPS/mobile/computer location), reviews written, past bookings of service providers, and the user's interaction with other users in the style app. Identification of matching service providers may analogously be based on service provider data 312 which may include one or more of: a service provider's, profile, profile images, shared images, tagged images, liked images, saved images, style selections on profile, services provided to users, reviews by other users, ratings by other users, favorites by other users, lists by other users, past bookings by other users, information from social networks, availability, proximity, and the service provider's interaction with other users in the style app. The visual output 320 in the user interface may comprise a plurality of summary profiles of service providers that may include one or more images of one or more preferred styles. Alternatively or additionally, the visual output 320 may include icons that link to an image gallery of a service provider or other user, to another user's favorite list, or to a video. The peripheral component used for the visual display may be selected from the following: a screen, projection, printer, glasses, contact lenses, and a wearable visual. The user interface on one or more of its pages may comprise a button that allows a consumer to select one or more filtering options 312 that may be automatically pre-populated as herein described.

To perform the above steps, the system may include: a search module to perform a search by, for example, limiting providers by one or more relevant category (e.g. availability in time and proximity in location); a selection module that determines styles relevant to a user; a display module that displays a selection of the most relevant service providers via a user interface with style images or icons providing a link to images or videos showing a particular style; and/or a data store with user preferences from user profiles. The system comprises one or more data store for user data, service provider data, and search data, and may optionally save searches or index data for faster future retrieval.

The peripheral component of the system to provide the visual output may be any suitable peripheral device or peripheral of a computing device that is operably connected to the rest of system and allows a visual representation of the determined style-specific service providers; for example, without limitation, a screen, projection, printer, glasses, contact lenses, and wearable visual. One of ordinary skill in the art would appreciate that there are various devices that could be used to provide the visual output of the system and embodiments of the present invention are contemplated for use with any such suitable configuration.

A user's or subscriber's images that are placed into the system as well as external images detected in a search may be analyzed by an image recognition module of the system that has image recognition, identification, and detection capabilities and can determine a particular style category for certain objects/classes of objects. Style categories and object classes may, for example, include particular hairs style or cuts, human hand or nails, certain fashion accessories, and even outfits, tattoos, objects they depict, and their particular styles etc. These modules generally include AI (artificial intelligence) or machine learning functionality well known in the art.

In object recognition or classification, one or several pre-specified or learned objects or object classes can be recognized, usually together with their 2D positions in the image. Illustrative standalone programs that can perform this function include Blippar, Google Goggles, and LikeThat. In image identification an individual instance of an object is recognized. Examples include identification of a specific person's face or particular features such as hairstyle, tattoos, or outfit. In image detection, image data is scanned for a specific condition, e.g. presence of a particular accessory, or detection of a human hand (e.g. with painted nails). Detection based on relatively simple and fast computations is sometimes used for finding smaller regions of interesting image data which can be further analyzed by more computationally demanding techniques to produce a correct interpretation and determine a particular category mentioned herein, such as a particular hairstyle etc.

Suitable algorithms for image recognition, identification and detection are typically based on convolutional neural networks. The ImageNet Large Scale Visual Recognition Challenge, which is a benchmark in object classification and detection, with millions of images and hundreds of object classes, may serve as an illustration. Performance of convolutional neural networks on the ImageNet tests is now close to that of humans. Available web-based options for image recognition and related Application Program Interfaces (API) for software applications include products from Microsoft, Google, IBM, Clarifai, and Cloud Sight.

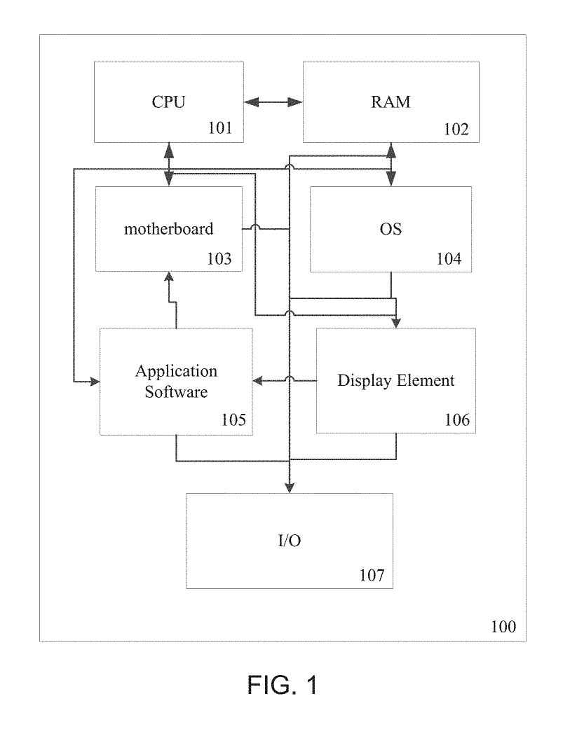

An illustrative representation of a computing device appropriate for use with embodiments of the system of the present invention is shown in FIG. 1. The computing device 100 can generally be comprised of a Central processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

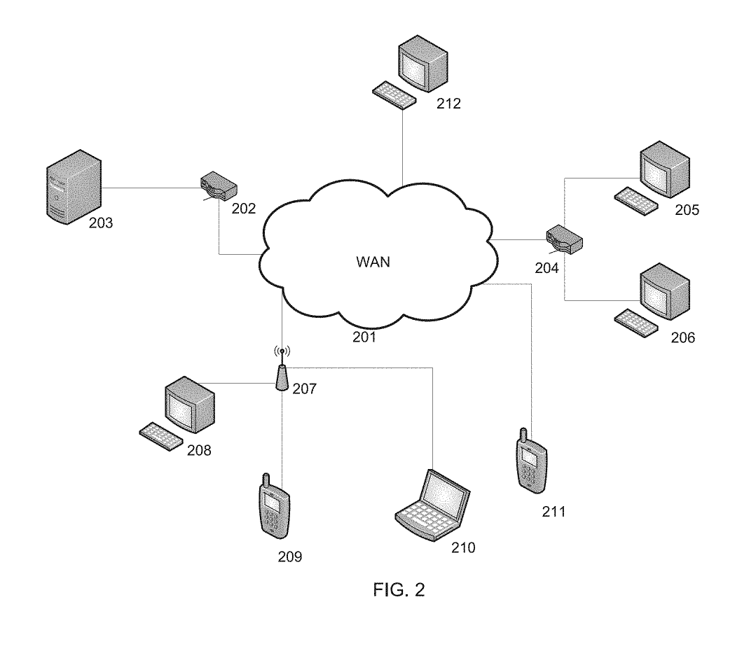

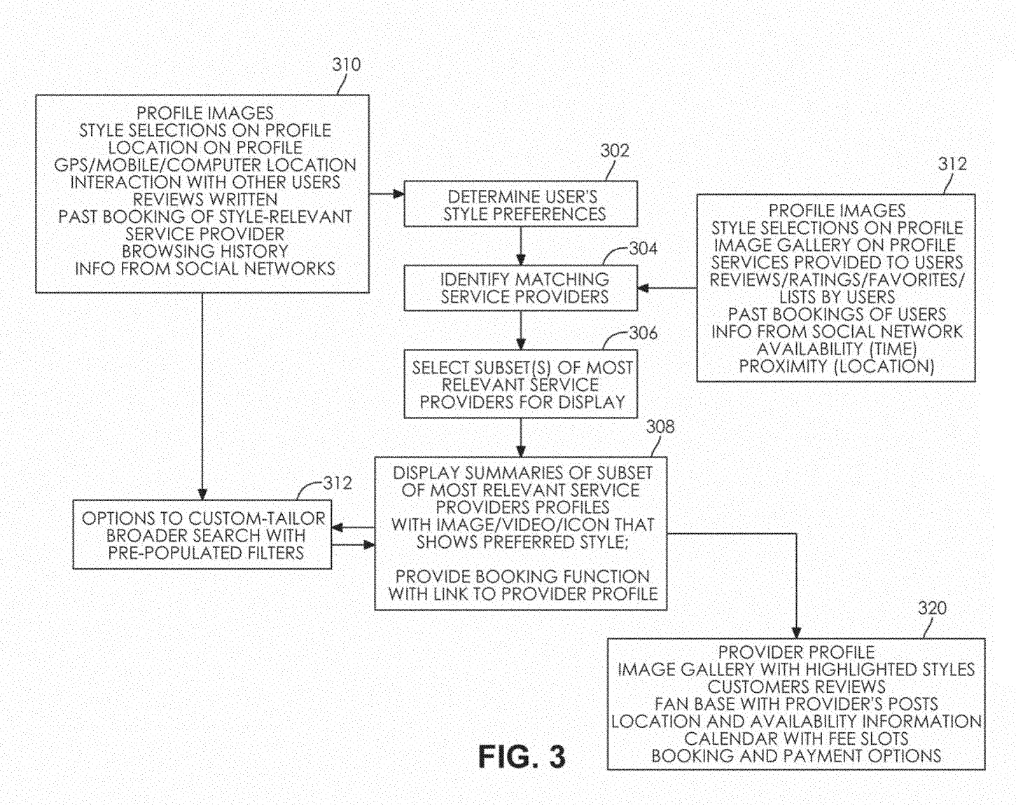

Various examples of such general-purpose multi-unit computer networks suitable for embodiments of the invention, their typical configuration and many standardized communication links are well known to one skilled in the art, as explained in more detail and illustrated by FIG.2, which is discussed herein-below.

According to an exemplary embodiment of the present invention, data may be provided to the system, stored by the system and/or provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present invention, some of the applications of the present invention may not be accessible when not connected to a network, however a user or a module/component of the system itself may be able to compose data offline from the remainder of the system that will be consumed by the system or its other components when the user/offline system component or module is later connected to the system network.

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 1, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present invention, and embodiments of the present invention are contemplated for use with any communications means.

Traditionally, a computer program consists of a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. There may be aspects of this invention that may be practiced without the implementation of some features as they are described. It should be understood that some details have not been described in detail in order to not unnecessarily obscure the focus of the invention. The invention is capable of myriad modifications in various obvious aspects, all without departing from the spirit and scope of the present invention. Accordingly, the drawings and descriptions are to be regarded as illustrative rather than restrictive in nature.

What is claimed is:

1. A system for identifying and booking style-critical service providers comprising:
a search module;
a selection module;
a display module;
a data store comprising at least one of
user data,
service provider data, and
search data; and
a visual output device;
wherein the display module is configured to display a user interface via the visual output device.

2. The system of claim 1 wherein the user interface is configured to display a profile which is customized according to a user's choice of one or more of hair style, nail style, makeup style, tattoo style, and fashion style.

3. The system of claim 1 wherein the service provider data comprises one or more of a name, a business address, a service location, an availability schedule, a set of services provided, and a set of particular styles specialized in for each service provider having a profile on the system.

4. The system of claim 1 wherein the user interface comprises a service provider profile which comprises one or more of a name, business address, service location, and images.

5. The system of claim 4 wherein the images are pictures of styles specialized in by a service provider.

6. The system of claim 4 further comprising plurality of tabs, buttons, icons, and dropdown menus.

7. The system of claim 6 wherein at least one of the plurality of buttons is configured to make a booking, at least one of the plurality of buttons is configured to make a phone call to a service provider, and at least one of the plurality of buttons is configured to process a payment through the system.

8. The system of claim 1 wherein the interface displays a review module configured to enable to user to supply the system with a review of a service provider's work which comprises one or more of a rating, a textual description, and one or more pictures of the service provider's work that is being reviewed.

9. The system of claim 1 wherein the interface displays featured products selected for display by the system's determination of a user's preferences based on one or more of: a user profile in the system, a user profile in a user's social network sites, a user's browsing history, a user's appointment history, a user's reviews, a user's images placed in a review, and ratings a user's images receive.

10. The system of claim 1 wherein the display module comprises a mobile device.

11. The system of claim 10 wherein the system is configured to respond to Bluetooth Low Energy Beacon interaction by presenting at least one of notifications and advertisements when the mobile device is within range of a Bluetooth Low Energy Beacon.

12. The system of claim 10 wherein the mobile device comprises imaging means operable to scan a Quick Response code and thereby check a user in to a service provider's location.

13. A method for identifying and booking style-critical service providers comprising the steps of:
determining a user's style preferences;
identifying matching service providers;
selecting relevant service providers; and
displaying relevant service providers.

14. The method of claim 13 wherein the step of determining a user's style preferences depends on user data comprising one or more of: the user's browsing history, the user's purchasing history, the user's profile, the user's profile images, the user's shared images, the user's tagged images, the user's liked images, the user's saved images, the user's location on profile, and the user's current location.

15. The method of claim 13 wherein the step of identifying matching service providers is based on service provider data comprising one or more of: a service provider's, the service provider's profile, the service provider's profile images, the service provider's shared images, the service provider's tagged images, the service provider's liked images, the service provider's saved images, the service provider's style selections on profile, the service provider's services provided to users, the service provider's reviews by other users, the service provider's ratings by other users, the service provider's favorites by other users, the service provider's lists by other users, the service provider's past bookings by other users, the service provider's information from social networks, the service provider's availability, and the service provider's proximity.

16. The method of claim 13 wherein the step of displaying relevant service providers comprises displaying summaries of a subset of selected service provider profiles and providing a booking function linked to a service provider's profile.

17. The method of claim 16 wherein the step of displaying relevant service providers further comprises displaying via a visual output at least one of a plurality of summary profiles of style providers, an image gallery, a user's favorite list, and a video.

18. A system for identifying and booking style-critical service providers comprising a non-transitory, computer readable recording medium containing a computer program, which when executed by a processor, causes the system to perform the steps of:
determining a user's style preferences
based on service provider data comprising one or more of: a service provider's, the service provider's profile, the service provider's profile images, the service provider's shared images, the service provider's tagged images, the service provider's liked images, the service provider's saved images, the service provider's style selections on profile, the service provider's services provided to users, the service provider's reviews by other users, the service provider's ratings by other users, the service provider's favorites by other users, the service provider's lists by other users, the service provider's past bookings by other users, the service provider's information from social networks, the service provider's availability, and the service provider's proximity;
identifying matching service providers;
selecting relevant service providers; and
displaying relevant service providers via a component of a display module of the system.

19. The system of claim 18 wherein the step of identifying matching service providers is based on service provider data comprising one or more of: a service provider's, the service provider's profile, the service provider's profile images, the service provider's shared images, the service provider's tagged images, the service provider's liked images, the service provider's saved images, the service provider's style selections on profile, the service provider's services provided to users, the service provider's reviews by other users, the service provider's ratings by other users, the service provider's favorites by other users, the service provider's lists by other users, the service provider's past bookings by other users, the service provider's information from social networks, the service provider's availability, and the service provider's proximity.

20. The system of claim 18 wherein the step of displaying relevant service providers comprises displaying summaries of a subset of selected service provider profiles and providing a booking function linked to a service provider's profile and further comprises displaying via a visual output at least one of a plurality of summary profiles of style providers, an image gallery, a user's favorite list, and a video.
